(19) United States
(12) Patent Application Publication
(10) Pub. No.: US 2010/0026639 A1
(43) Pub. Date: Feb. 4, 2010

(54) LIQUID CRYSTAL DISPLAY AND TOUCH SENSING METHOD THEREOF

(75) Inventors: Jae-Hoon Lee, Seoul (KR); Seiki Takahashi, Cheonan-si (KR); Bong-Hyun You, Yongin-si (KR); Byoung-Jun Lee, Cheonan-si (KR)

Correspondence Address: H.C. PARK & ASSOCIATES, PLC, 8500 LEESBURG PIKE, SUITE 7500, VIENNA, VA, 22182, US

(73) Assignee: Samsung Electronics Co., Ltd., Suwon-si (KR)

(21) Appl. No.: 12/347,421

(22) Filed: Dec. 31, 2008

(30) Foreign Application Priority Data
Aug. 4, 2008 (KR) 2008-76172

(51) Int. Cl. G06F 3/041

(52) U.S. Cl. 345/173

(57) ABSTRACT

A liquid crystal display includes a liquid crystal panel that has a plurality of pixels and a plurality of sensors, and a touch sensing circuit that compares a sensing voltage detected by at least one sensor with a reference voltage that corresponds to the at least one sensor to determine the at least one sensor is touched. A level of the reference voltage is calibrated by taking operation characteristics of the sensors into consideration.

### CROSS REFERENCE TO RELATED APPLICATION

This application claims priority from and the benefit of Korean Patent Application No. 2008-76172, filed on Aug. 4, 2008, which is hereby incorporated by reference for all purposes as if fully set forth herein.

### BACKGROUND

1. Field of the Invention

The present invention relates to a liquid crystal display. More particularly, the present invention relates to an apparatus and a method capable of detecting a touch to a liquid crystal display.

2. Discussion of the Background

Recently, as personal computers and televisions have followed a tendency toward lightness and slimness, lightness and slimness of display apparatuses has been required. Thus, cathode ray tubes (CRT) have been replaced with flat panel displays.

The flat panel display includes a liquid crystal display (LCD), a field emission display (FED), an organic light emitting display (OLED), a plasma display panel (PDP), and the like. Among them, the LCD has been extensively used as a display apparatus in a mobile apparatus, e.g. a portable computer, a personal digital assistant (PDA), and a mobile phone, because of its superior image quality, lightness, slimness, and low power consumption. The LCD includes two transparent substrates (glass substrates) having pixel electrodes and common electrodes, and a liquid crystal layer disposed between the substrates. The LCD adjusts transmittance of light passing through the liquid crystal layer by adjusting the intensity of an electric field applied to the liquid crystal layer, thereby displaying a desired image.

Recently, in order to improve a user interface of a display apparatus such as an LCD, a touch screen panel (TSP) has been actively developed. Using the TSP, a user writes a character or draws a picture on a screen of a display apparatus, or touches an icon on the screen by using a finger or a touch pen such as a stylus, so that a command is executed through an apparatus such as a computer. However, an LCD with the TSP increases the manufacturing cost due to an additional installation of the TSP, reducing product yields due to a process of bonding the TSP to a liquid crystal panel, reduces luminance of the liquid crystal panel, and increases the thickness of a product.

In order to solve such problems, technologies have developed to install a sensor in an LCD, instead of attaching the TSP to the LCD. The sensor detects variation in light or pressure applied to a screen by a finger of a user, to detect whether the finger of the user has touched the screen of the LCD.

### SUMMARY

The present invention provides an apparatus and a method capable of exactly detecting a touch to sensors in an LCD.

The present invention also provides an apparatus and a method capable of self-calibrating a level of voltage serving as a reference when detecting a touch to sensors.

Additional features of the invention will be set forth in the description which follows, and in part will be apparent from the description, or may be learned by practice of the invention.

The present invention discloses a liquid crystal display that includes a liquid crystal panel and a touch sensing circuit. The liquid crystal panel includes a plurality of pixels and a plurality of sensors. The touch sensing circuit compares a sensing voltage detected by at least one sensor with a reference voltage that corresponds to the at least one sensor to determine whether a touch event occurs to the sensor. A level of the reference voltage is calibrated by taking operation characteristics of the sensors into consideration.

The present invention also discloses a liquid crystal display that includes a liquid crystal panel, a driving unit, a touch sensing circuit, and a timing control unit. The liquid crystal panel includes a plurality of pixels and a plurality of sensors. The driving unit generates a data voltage that corresponds to an image signal to be displayed on the pixels. The touch sensing circuit compares a sensing voltage detected by at least one sensor with a reference voltage that corresponds to the at least one sensor to determine whether a touch event occurs to the at least one sensor. The timing control unit controls operations of the driving unit and the touch sensing circuit. A level of the reference voltage is calibrated by taking operation characteristics of the sensors into consideration.

The present invention also discloses a touch sensing method of a liquid crystal panel having a plurality of pixels and a plurality of sensors. A calibration voltage that corresponds to each sensor is generated in consideration of voltage characteristics of each sensor that corresponds to a non-touch event during a calibration operation. A sensing voltage is received from at least one sensor during a normal operation. The sensing voltage is compared with the calibration voltage that corresponds to the at least one sensor. Whether a touch occurs to the at least one sensor is determined based on a result obtained by comparing the sensing voltage with the calibration voltage.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a view showing a structure of a liquid crystal panel, to which the present invention is applied.

FIG. 2 is an equivalent circuit of a pixel and a sensor as shown in FIG. 1, and a block diagram showing a structure of a touch sensing circuit according to an exemplary embodiment of the present invention.

FIG. 3 and FIG. 4 are graphs showing voltage characteristics for touch and non-touch events as shown in FIG. 1.

FIG. 5 and FIG. 6 are views showing an example in which a calibration voltage is generated according to the present invention.

FIG. 7 is a circuit diagram showing a touch sensing circuit according to an exemplary embodiment of the present invention.

FIG. 8 is a timing chart of control signals that control an operation of the touch sensing circuit as shown in FIG. 7.

FIG. 9 is a block diagram showing a touch sensing circuit according to another exemplary embodiment of the present invention.

FIG. 10 is a block diagram showing a liquid crystal display including a touch sensing circuit according to the present invention.

FIG. 11 is a view showing a scanning scheme for sensors provided in a liquid crystal panel.

FIG. 12 is a flowchart showing a touch sensing operation of a liquid crystal display according to the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

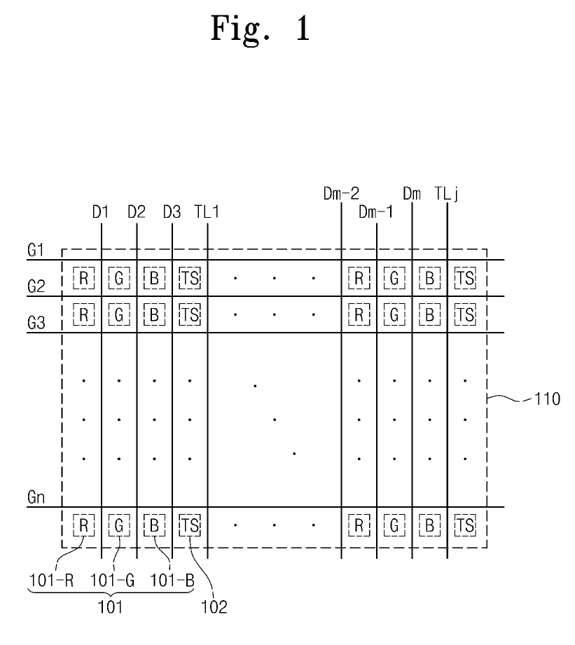

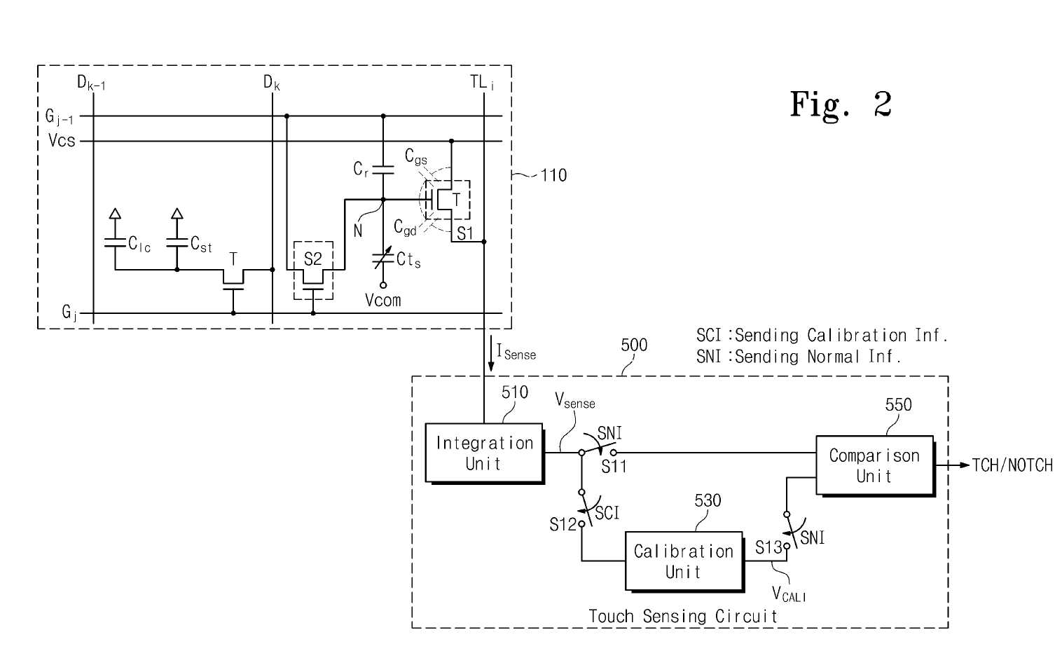

FIG. 1 is a view showing a structure of a liquid crystal panel to which the present invention is applied. FIG. 2 shows an equivalent circuit of a pixel and a sensor as shown in FIG. 1, and a structure of the touch sensing circuit according to an exemplary embodiment of the present invention.

The liquid crystal panel 110 as shown in FIG. 1 and FIG. 2 represents a panel in which a liquid crystal panel is integrally formed with a touch screen panel or a liquid crystal panel having a touch screen function. The structure of the liquid crystal panel 110 as shown in FIG. 1 and FIG. 2 is for illustrative purpose only, and it should be noted that elements (e.g. pixels and sensors) of the liquid crystal panel 110, a method of forming the elements, and interconnection and connection relation of the elements can be variously modified.

Referring to FIG. 1, the liquid crystal panel 110 includes a plurality of gate lines G₁ to Gₙ extending in one direction. The liquid crystal panel 110 includes a plurality of data lines D₁ to Dₘ and a plurality of sensor lines TL₁ to TLⱼ, which cross the gate lines G₁ to Gₙ. As shown in FIG. 2, the liquid crystal panel 110 further includes a plurality of sensing voltage supply lines VCS extending in the direction identical to the extending direction of the gate lines G₁ to Gₙ.

A plurality of pixels 101 (i.e. 101-R, 101-G and 101-B) are connected with areas in which the gate lines G₁ to Gₙ cross the data lines D₁ to Dₘ, respectively. Further, a plurality of sensors 102 are connected with areas in which the gate lines G₁ to Gₙ cross the sensor lines TL₁ to TLⱼ, respectively. The pixels 101 and the sensors 102 are arranged in a matrix type in a display area of the liquid crystal panel 110.

One pixel 101 may include a red pixel 101-R, a green pixel 101-G, and a blue pixel 101-B, and one sensor 102 can be allocated to one pixel 101. At this time, the red pixel 101-R, the green pixel 101-G, the blue pixel 101-B, and the sensor 102 can be defined as one display group. The red pixel 101-R, the green pixel 101-G, the blue pixel 101-B, and the sensor 102 constituting one display group can be continuously disposed in a row direction. The red pixel 101-R, the green pixel 101-G, and the blue pixel 101-B are connected with the corresponding data lines D1 to D3, respectively, and the sensor 102 is connected with the corresponding sensor line TL₁ of the sensor lines TL₁ to TLⱼ. One sensor line can be disposed every three data lines. However, the structure and arrangement of the display group as shown in FIG. 1 is one example of the present invention, and a structure of pixels and a sensor constituting each display group can be variously modified. Further, interconnections for data and sensor lines can be variously configured according to the structure of each display group.

Referring to FIG. 2, each pixel 101 includes a TFT (thin film transistor) T and a liquid crystal capacitor C_{1C}. Further, each pixel 101 may further include a storage capacitor Cₛₜ. The thin film transistor T has a gate terminal connected with the corresponding gate line Gⱼ and a source terminal connected with the corresponding data line Dₖ. A drain terminal of the thin film transistor T can be commonly connected with one terminal of the liquid crystal capacitor C_{1C} and one terminal of the storage capacitor Cₛₜ.

A first switch S1 is connected between the corresponding sensor line TLᵢ and the corresponding sensing voltage supply line VCS. A second switch S2 is connected between the corresponding gate line G₍ⱼ₋₁₎ and a first node N. The first switch S1 is turned on or off in response to a voltage of the first node N. The second switch S2 is turned on or off by the subsequent gate line Gⱼ. A reference capacitor Cᵣ is connected between the gate line G₍ⱼ₋₁₎ and the first node N. A sensor capacitor Ctₛ has one terminal connected with the first node N and the other terminal receiving common voltage V_{com}. The sensor capacitor Ctₛ can be prepared in the form of a variable capacitor having a variable capacitance value. Preferably, the first and second switches S1 and S2 include thin film transistors, respectively.

As a finger of a user touches the sensor 102, current on the sensor line TLᵢ connected with the sensor 102 is changed. The current flowing through the sensor line TLᵢ will be referred to as sensing current Iₛₑₙₛₑ. The sensing current Iₛₑₙₛₑ can be modeled as expressed by an equation 1 below.

Iₛₑₙₛₑ=k*(V_{GS}−Vₜₕ)² (k=0.5*u*C_{SiNx}*W/L) Equation 1

In equation 1, the C_{SiNx} denotes a capacitance value according to components of insulating layers of the capacitors constituting the sensor 102, the Vₜₕ denotes threshold voltage of the thin film transistor constituting the sensor 102, and the V_{GS} denotes gate-source voltage of the thin film transistor.

As a touch or non-touch event occurs in the sensor 102, the gate-source voltage V_{GS} of the thin film transistor constituting the sensor 102 is changed, causing variation in the sensing current Iₛₑₙₛₑ.

The touch sensing circuit 500 receives the sensing current Iₛₑₙₛₑ to detect a touch to the sensor 102. According to the present exemplary embodiment, when the touch sensing circuit 500 detects a touch to the sensor 102, the touch sensing circuit 500 uses calibration voltage V_{CALI} having a self-calibrated level in each sensor 102 as a reference voltage, instead of the reference voltage having a fixed level. The calibration voltage V_{CALI} is generated based on operation characteristics of each sensor 102, particularly, voltage characteristics of touch and non-touch events of each sensor 102. In order to generate the calibration voltage V_{CALI}, the touch sensing circuit 500 of the present invention includes an integration unit 510, a calibration unit 530 and a comparison unit 550.

The integration unit 510 generates sensing voltage Vₛₑₙₛₑ by integrating the sensing current Iₛₑₙₛₑ. The sensing voltage Vₛₑₙₛₑ can be modeled as expressed by an equation 2 below.

$${V}_{sense} = \frac{{I}_{sense} \times {t}_{sense}}{{C}_{ro}} = \frac{{k ( {V}_{GS} - {V}_{th} )}^{2} \times {t}_{sense}}{{C}_{ro}} \qquad Equation 2$$

In equation 1, the k can be defined as (0.5*u*C*W/L). The Cᵣₒ denotes a capacitance value of the integration unit 510 and the tₛₑₙₛₑ denotes a sensing time. As the liquid crystal panel 110 is fabricated in a larger size, the following non-uniformity may occur in a process for a large glass substrate. For example, the threshold voltage Vₜₕ, mobility, and capacitance C_{siNx} of the thin film transistor in the sensor 102 may be non-uniform. In such a case, even if the same gate-source voltage V_{GS} is determined by the sensor 102, the sensing current Iₛₑₙₛₑ may be changed. Particularly, if the thin film transistor operates for a long time, a level of the threshold voltage Vₜₕ of the thin film transistor may be shifted due to electrical degradation characteristics of the a-Si thin film transistor. Further, when a cell gap is non-uniform in each sensor 102, the gate-source voltage V_{GS} of the thin film transistor may be changed. For example, a cell gap in a large glass substrate may be non-uniform in panel to panel or cell to cell at the ratio of about 30%. If the cell gap is non-uniform, liquid crystal capacitance in the sensor 102 becomes non-uniform, so that the gate-source voltage V_{GS} of the thin film transistor is changed. Thus, even if the same threshold voltage Vₜₕ of the thin film transistor is formed in a glass substrate, the sensing current Iₛₑₙₛₑ is changed regardless of a touch to the sensor 102. In addition, as sensing time of reading a circuit of each sensor 102 is changed, the sensing current Iₛₑₙₛₑ may be changed.

As described above, the process characteristics of the liquid crystal panel 110 and resulting variation of the sensing current Iₛₑₙₛₑ become important factors when the touch to the sensor 102 is determined according to the present invention. The present invention generates the calibration voltage V_{CALI} having a level self-calibrated according to the voltage characteristics of each sensor 102, and determines a touch event to the sensor 102 based on the calibration voltage V_{CALI} serving as the reference voltage. As a result, the sensor 102 can be prevented from malfunctioning and the sensing characteristics of the sensor 102 can be improved.

The touch sensing circuit 500 of the present invention has two operation modes, i.e. a normal mode and a calibration mode. In the calibration mode, the calibration voltage V_{CALI} is generated based on the operation characteristics of the sensor 102 upon a non-touch event. The calibration voltage V_{CALI} is generated from the calibration unit 530 in a calibration interval. The calibration mode can be basically defined as an interval in which a non-touch event occurs in the liquid crystal panel 110. For example, the calibration mode may be defined as various modes such as user selection modes, or may also be set using a timer when a normal operation is performed and n frames pass (n denotes an integral number of 1 or more) after the liquid crystal panel 110 is turned on.

The normal mode represents a normal operation interval in which user input is generated. In the normal mode, the sensing voltage Vₛₑₙₛₑ detected by the sensor 102 is compared with the calibration voltage V_{CALI} to detect a touch to the sensor 102. The comparison of the sensing voltage Vₛₑₙₛₑ and the calibration voltage V_{CALI} is performed by the comparison unit 550 in the normal mode. In order to exactly perform the comparison, the calibration mode is preferably performed at least one time before the normal mode is established. Thus, the self-calibration operation can be performed when the liquid crystal display 100 is powered on.

The comparison unit 550 generates a touch signal TCH or a non-touch signal NOTCH according to the comparison result. For example, if a difference exists between the sensing voltage Vₛₑₙₛₑ and the calibration voltage V_{CALI}, the comparison unit 550 determines that a touch event has occurred in a selected sensor 102, to generate the touch signal TCH. However, if no difference exists between the sensing voltage Vₛₑₙₛₑ and the calibration voltage V_{CALI}, the comparison unit 550 determines that the touch event has not occurred in the selected sensor 102, to generate the non-touch signal NOTCH. The touch signal TCH or the non-touch signal NOTCH generated from the comparison unit 550 is used to recognize a command input by a user.

In the calibration and normal modes, the sensing voltage Vₛₑₙₛₑ and the calibration voltage V_{CALI} are provided through switching operations of first, second, and third switches S11, S12, and S13 provided in the touch sensing unit 500. The switching operations of the first and third switches S11 and S13 are controlled by an SNI (sending normal information) signal. The switching operation of the second switch S12 is controlled by an SCI (sending calibration information) signal. The time point at which the SNI and SCI signals are activated or deactivated can be controlled by a control logic (e.g. a timing control unit (not shown)) of the touch sensing unit 500.

The generation function (i.e. self-calibration function of reference voltage) of the calibration voltage V_{CALI} as described above is performed based on voltage characteristics for the touch and non-touch events (particularly, the non-touch event) of each sensor 102. The voltage characteristics for the touch and non-touch events of each sensor 102 are described below.

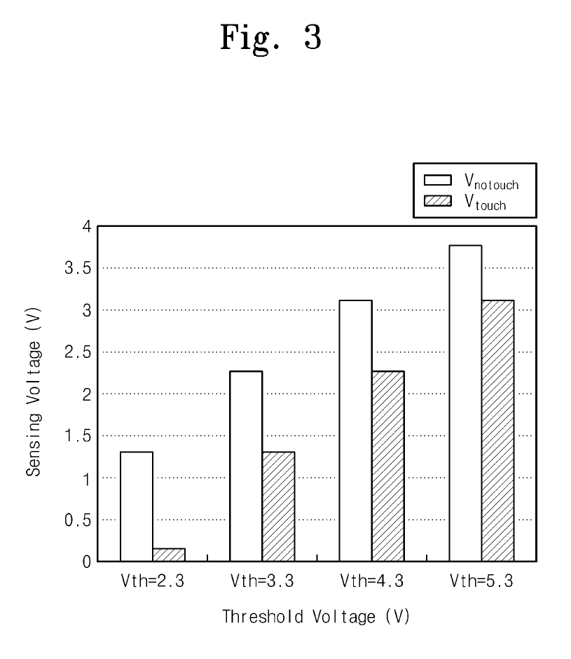

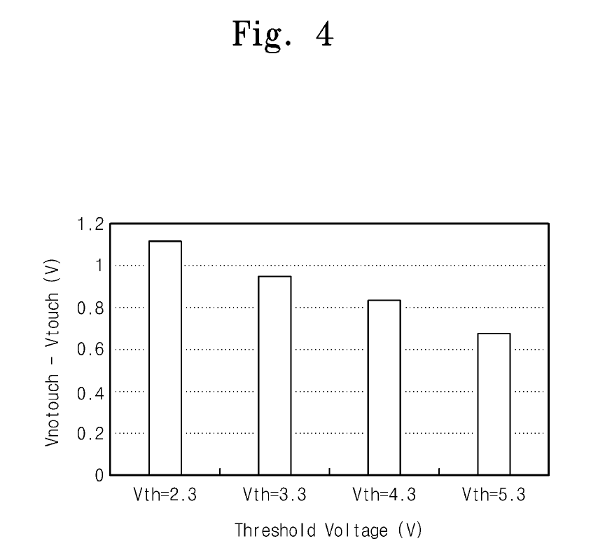

FIG. 3 and FIG. 4 are graphs showing the voltage characteristics for touch and non-touch events of each sensor as shown in FIG. 1. FIG. 3 shows characteristics of sensing voltage when the sensor 102 is touched or not according to variation of the threshold voltage Vₜₕ of the thin film transistor, and FIG. 4 shows a difference of sensing voltage when the sensor 102 is touched or not touched according to variation of the threshold voltage Vₜₕ of the thin film transistor. In FIG. 3 and FIG. 4, the V_{touch} denotes sensing voltage Vₛₑₙₛₑ corresponding to the touch event and the V_{notouch} denotes sensing voltage Vₛₑₙₛₑ corresponding to the non-touch event.

Referring to FIG. 3, as the threshold voltage Vₜₕ of the thin film transistor is changed, a level of the sensing voltage V_{touch} corresponding to the touch event and a level of the sensing voltage V_{notouch} corresponding to the non-touch event are considerably changed. For example, when the threshold voltage Vₜₕ of the thin film transistor is about 2.3V, the sensing voltage V_{touch} corresponding to the touch event is about 0.2V. Further, when the threshold voltage Vₜₕ of the thin film transistor is about 5.3V, the sensing voltage V_{touch} corresponding to the touch event is about 3.1V. The sensing voltage V_{touch} corresponding to the touch event has large variation (e.g. voltage variation of about 2.9V) as the threshold voltage Vₜₕ of the thin film transistor is changed. Such characteristics are applied to the sensing voltage V_{notouch} corresponding to the non-touch event. For example, when the threshold voltage Vₜₕ of the thin film transistor is about 2.3V, the sensing voltage V_{notouch} corresponding to the non-touch event is about 1.3V. Further, when the threshold voltage Vₜₕ of the thin film transistor is about 5.3V, the sensing voltage V_{notouch} corresponding to the non-touch event is about 3.7V. The sensing voltage V_{notouch} corresponding to the non-touch event has large variation (e.g. voltage variation of about 2.4V) as the threshold voltage Vₜₕ of the thin film transistor is changed.

However, as shown in FIG. 4, although the threshold voltage Vₜₕ of the thin film transistor is changed, the difference between the sensing voltage V_{touch} corresponding to the touch event and the sensing voltage V_{notouch} corresponding to the non-touch event is not large. For example, when the threshold voltage Vₜₕ of the thin film transistor is about 2.3V, the difference between the sensing voltage V_{touch} corresponding to the touch event and the sensing voltage V_{notouch} corresponding to the non-touch event is about 1.1V. Further, when the threshold voltage Vₜₕ of the thin film transistor is about 5.3V, the difference between the sensing voltage V_{touch} corresponding to the touch event and the sensing voltage V_{notouch} corresponding to the non-touch event is about 0.7V. According to the present exemplary embodiment, the minimum voltage difference between V_{touch} and V_{notouch} is about 0.7V and the maximum voltage difference between V_{touch} and V_{notouch} is about 1.1V, as shown in FIG. 4.

Absolute values of the sensing voltage V_{touch} corresponding to the touch event and the sensing voltage V_{notouch} corresponding to the non-touch event considerably vary depending on the threshold voltage Vₜₕ of the thin film transistor (see FIG. 3). However, the difference between the sensing voltage V_{touch} corresponding to the touch event and the sensing voltage V_{notouch} corresponding to the non-touch event is considerably reduced as the threshold voltage Vₜₕ is changed (see FIG. 4). Thus, the present invention generates the calibration voltage V_{CALI}, to be used to detect existence of a touch, based on the characteristics of the difference between the sensing voltage V_{touch} corresponding to the touch event and the sensing voltage V_{notouch} corresponding to the non-touch event, and then determines the touch and non-touch events of the sensor 102 by using the calibration voltage V_{CALI} serving as the reference voltage.

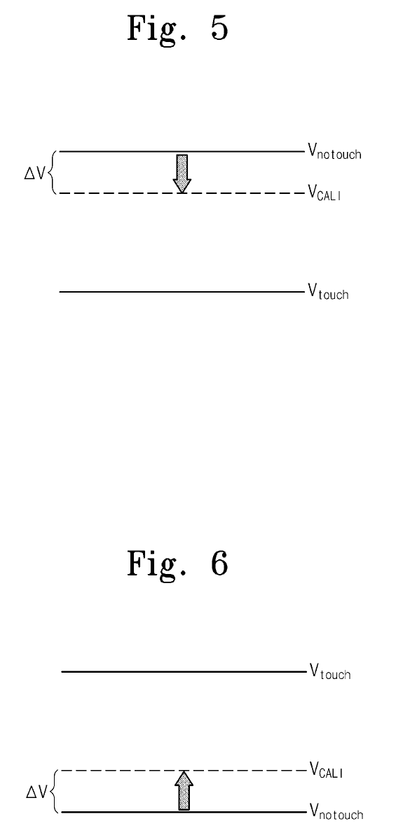

FIG. 5 and FIG. 6 are views showing an example in which a calibration voltage V_{CALI} is generated according to the present invention. FIG. 5 shows an example in which the calibration voltage V_{CALI} is generated when the sensing voltage V_{touch} corresponding to the touch event has a level lower than that of the sensing voltage V_{notouch} corresponding to the non-touch event. FIG. 6 shows an example in which the calibration voltage V_{CALI} is generated when the sensing voltage V_{touch} corresponding to the touch event has a level higher than that of the sensing voltage V_{notouch} corresponding to the non-touch event.

Referring to FIG. 5 and FIG. 6, a level of the calibration voltage V_{CALI} is calibrated such that a predetermined difference ΔV is formed between the calibration voltage V_{CALI} and the sensing voltage V_{notouch} corresponding to the non-touch event. For example, the calibration voltage V_{CALI} may have a level lower than that of the sensing voltage V_{notouch} corresponding to the non-touch event by the difference ΔV (see FIG. 5), or the calibration voltage V_{CALI} may have a level higher than that of the sensing voltage V_{notouch} corresponding to the non-touch event by the voltage difference ΔV (see FIG. 6). The voltage difference ΔV used for voltage calibration is determined using the characteristics of the voltage difference between the sensing voltage V_{touch} corresponding to the touch event and the sensing voltage V_{notouch} corresponding to the non-touch event as shown in FIG. 4. For example, the voltage difference ΔV as shown in FIG. 5 and FIG. 6 may be about 0.1 V to about 0.3V. The value is calculated based on a case in which the smallest difference (0.7V in FIG. 4) is formed between the sensing voltage V_{touch} generated upon the touch event and the sensing voltage V_{notouch} generated upon the non-touch event. However, this is only an exemplary embodiment of the present invention, and the voltage difference ΔV to be used for the voltage calibration can be variously modified.

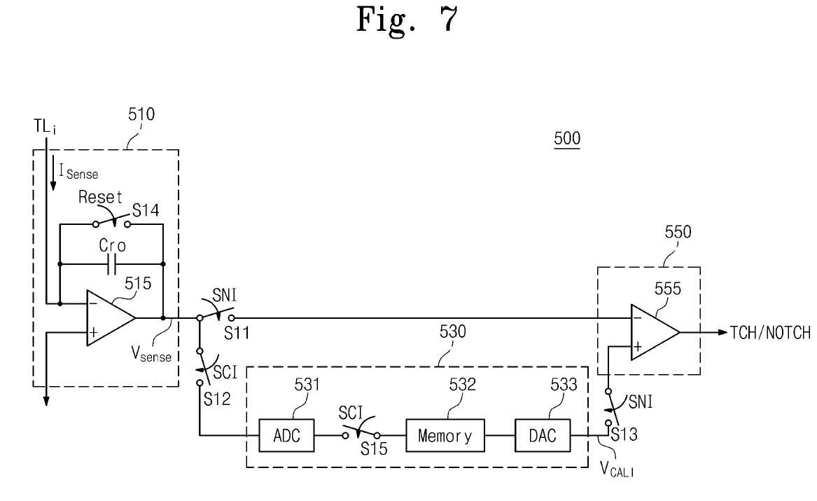

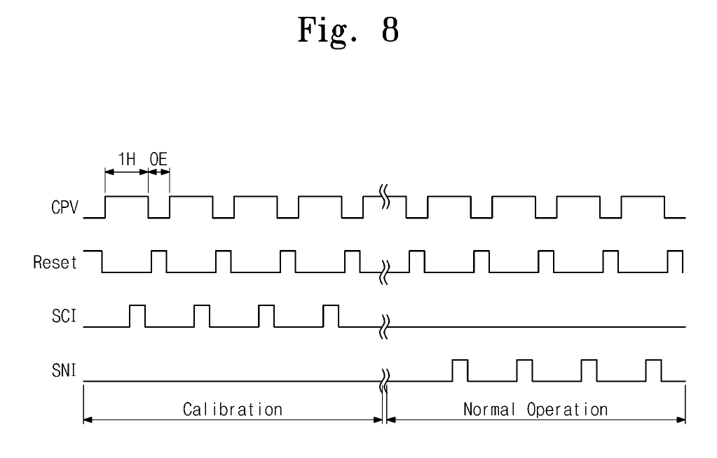

FIG. 7 is a circuit diagram showing a the touch sensing circuit according to an exemplary embodiment of the present invention, and FIG. 8 is a timing chart of control signals that control an operation of the touch sensing circuit as shown in FIG. 7.

Referring to FIG. 8, the control signals that control the operation of the touch sensing circuit can be generated in response to a CPV (clock pulse vertical) signal that determines output of each sensor line TLᵢ in the liquid crystal panel 110. The control signals as shown in FIG. 8 can be controlled by the control logic (e.g. the timing control unit) (not shown).

The CPV signal is used to generate a gate scanning signal. When the CPV signal is in a high state, output of the TFT sensor 102 is accomplished in each horizontal line. In an interval (i.e. an OE interval) in which the CPV signal is in a low state, a reset signal becomes a high level. The reset signal is used to control the switching operation of the switch S14 as shown in FIG. 7.

In the calibration mode, the SCI signal is generated instead of the SNI signal. In the calibration mode, the SCI signal becomes a high level at the latter portion of an interval (i.e. 1H interval) in which the CPV signal is in a high state. However, in the normal mode, the SNI signal is generated instead of the SCI signal. In the normal mode, the SNI signal becomes a high level at the latter portion of the interval (i.e. 1H interval) in which the CPV signal is in the high state. The time point at which the SCI and SNI signals are activated or deactivated can be controlled by the control logic such as the timing control unit. The SCI and SNI signals are used to control the switching operations of the switches S11, S12, S13, and S15 as shown in FIG.

Referring again to FIG. 7, the touch sensing circuit 500 includes the integration unit 510, the calibration unit 530 and the comparison unit 550.

The integration unit 510 includes an OP amplifier 515, a capacitor C_{rO} and a switch S14. The switch S14 is turned on or off in response to the reset signal as shown in FIG. 8. For example, whenever the reset signal becomes the high level, the sensing current Iₛₑₙₛₑ applied to the sensor line TLᵢ is provided to the integration unit 510, and then accumulated through the capacitor C_{rO}. The integration unit 510 converts sensing current Iₛₑₙₛₑ accumulated for a predetermined time into a voltage and outputs the voltage. The voltage is referred to as the sensing voltage Vₛₑₙₛₑ. The sensing voltage Vₛₑₙₛₑ is output as analog signal. The sensing voltage Vₛₑₙₛₑ can be classified into a voltage detected when the touch event has occurred in the sensor 102 and a voltage detected when the non-touch event has occurred in the sensor 102. The sensing voltage Vₛₑₙₛₑ detected by and output through the integration unit 510 in the normal mode corresponds to the voltage detected when the touch or non-touch event has occurred. However, the sensing voltage Vₛₑₙₛₑ detected by and output through the integration unit 510 in the calibration mode corresponds to the voltage detected when the non-touch event has occurred.

The sensing voltage Vₛₑₙₛₑ detected by the integration unit 510 in the normal mode is provided to the comparison unit 550, and the sensing voltage Vₛₑₙₛₑ detected by the integration unit 510 in the calibration mode is provided to the calibration unit 530. The sensing voltage Vₛₑₙₛₑ is provided to the integration unit 510, the calibration unit 530, and the comparison unit 550 by the switching operations of the first and second switches S11 and S12 provided in the touch sensing circuit 500. The switching operations of the first and second switches S11 and S12 are controlled by the SCI and SNI signals as shown in FIG. 8.

The calibration unit 530 includes an analog-to-digital converter (ADC) 531, a switch S15, a memory 532 and a digital-to-analog converter (DAC) 533.

The ADC 531 converts the analog sensing voltage Vₛₑₙₛₑ generated from the integration unit 510 into a digital signal and outputs the digital signal. In the present exemplary embodiment, the ADC 531 can be prepared in the form of an ADC that outputs n-bit digital data. If the SCI signal becomes a high level at the latter portion of the interval (1H) in which the CPV signal is in a high state, the analog sensing voltage Vₛₑₙₛₑ generated from the integration unit 510 is transmitted to the n-bit ADC 531. The bit number of the ADC 531 is set in consideration of the output value V_{touch} and V_{notouch} of the sensor line TLᵢ. In the present invention, a 6-bit ADC 531 will be described as an example for the purpose of convenience.

For example, assuming that the sensing voltage Vₛₑₙₛₑ detected in the calibration mode, that is, the sensing voltage Vₛₑₙₛₑ corresponding to the non-touch event is about 3V, and the ADC 531 outputs 5V, the input voltage of 3V can be converted into 6-bit information of 100111. Then, the digital sensing voltage Vₛₑₙₛₑ generated from the ADC 531 in the calibration mode is provided to the memory 532 through the switch S15 in the calibration mode. The memory 532 stores all digital sensing voltage Vₛₑₙₛₑ for each sensor 102. The switching operation of the switch S15 is controlled by the SCI signal as shown in FIG. 8.

The memory 532 can be prepared in the form of an SRAM requiring no additional refresh time when the memory 532 operates. Further, the memory 532 can also be prepared in the form of a nonvolatile memory such as an EEPROM. When the number of the sensors 102 is set corresponding to 50% of display resolution in an FHD (full high definition) LCD having resolution of 1920*1080, the memory 532 requires a storage capacity of 0.52 Mbits (1920*1080/4=518400 bits). When each sensor 102 stores 6 bits of ADC results, the memory 532 requires storage capacity of the total 3.12 Mb (0.52*6). However, such storage capacity requirement may be considerably lower than that of a memory provided in the present TV panel. Particularly, in the case of a memory such as an SRAM, since a frame memory is provided in a mobile display apparatus to display a still image, an additional memory may not be necessary to realize the present invention.

In the calibration mode, the digital sensing voltage Vₛₑₙₛₑ stored in the memory 532 is provided to the DAC 533. The DAC 533 generates an analog calibration voltage V_{CALI} by calibrating the level of the digital sensing voltage Vₛₑₙₛₑ. Although not shown in the drawings, the DAC 533 includes a resistor array having a plurality of resistors in order to perform a digital-to-analog conversion operation. The present exemplary embodiment changes a distribution rate of the resistor array provided in the DAC 533, or a level of supply voltage of the DAC 533 to increase or decrease the level of the digital sensing voltage Vₛₑₙₛₑ by the predetermined voltage difference ΔV (e.g. about 0.1V to about 0.3V) (see FIG. 5 and FIG. 6). When the difference between the sensing voltage upon the touch event in the sensor 102 and the sensing voltage upon the non-touch event in the sensor 102 is greater than 0.7V, that is, when the voltage difference is sufficiently ensured, the DAC 533 can output the digital sensing voltage Vₛₑₙₛₑ, which is provided from the memory 532, as the calibration voltage V_{CALI}. Further, in order to prevent influence due to unexpected noise, ensuring a minimum voltage margin of about 0.1V to about 0.3V is necessary in consideration of an operation margin when the sensor 102 normally operates.

The calibration voltage V_{CALI} generated from the DAC 533 of the calibration unit 530 is provided to the comparison unit 550 in the normal mode. The calibration voltage V_{CALI} provided to the comparison unit 550 in the normal mode corresponds to the sensor 102 that is subject to a touch event. An operation timing related to data output of the memory 532 can be defined through an interface between the memory 532 and a host (not shown). Thus, detailed description about data input/output addresses and operation timing of the memory 532 will be omitted in the present invention.

The comparison unit 550 includes an OP amplifier 555 that performs a comparison operation. The comparison unit 550 compares the sensing voltage Vₛₑₙₛₑ provided from the integration unit 510 in the normal mode with the calibration voltage V_{CALI} provided from the calibration unit 530, thereby determining a touch event to the sensor 102 based on the comparison result. As described above, the present invention generates the calibration voltage V_{CALI} for each sensor included in the liquid crystal panel 110. Thus, the calibration voltage V_{CALI} compared by the comparison unit 550 reflects the operation characteristics of the sensor 102 that is subject to the touch event.

In the normal mode, the calibration voltage V_{CALI} is provided through the switching operation of the third switch S13 provided in the touch sensing circuit 500, and the sensing voltage Vₛₑₙₛₑ is provided through the switching operation of the first switch S11 provided in the touch sensing circuit 500. The switching operations of the first and third switches S11 and S13 are controlled by the SNI signal as shown in FIG. 8. The comparison unit 550 generates a digital touch signal TCH or a digital non-touch signal NOTCH according to a result obtained by detecting the touch event to the sensor 102. Then, the touch signal TCH or the non-touch signal NOTCH is used to recognize a command input by a user.

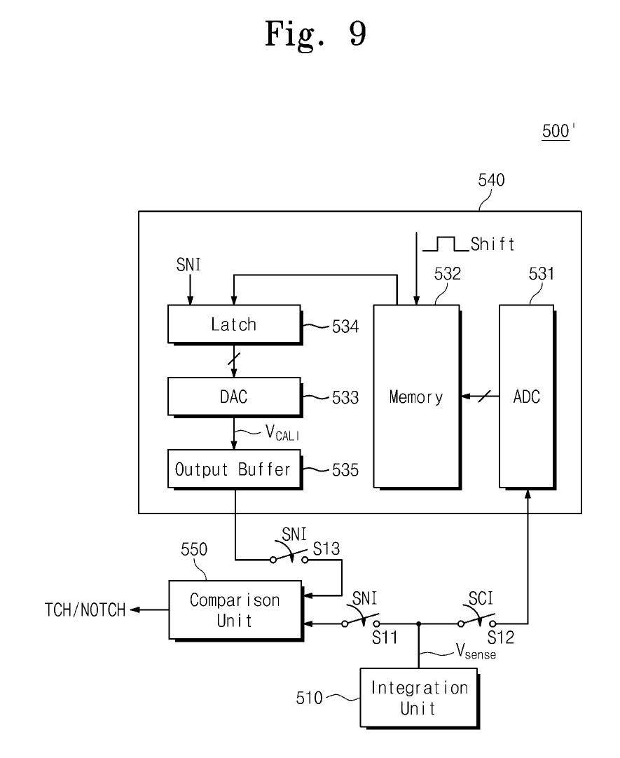

FIG. 9 is a block diagram showing a touch sensing circuit according to another exemplary embodiment of the present invention. The touch sensing circuit 500′ of FIG. 9 is controlled by the control signals as shown in FIG. 8, and the time point at which the control signals are activated or deactivated can be controlled by the control logic such as the timing control unit.

Referring to FIG. 9, the touch sensing circuit 500′ includes the ADC 531, the memory 532, the DAC 533, a latch 534 and an output buffer 535. The touch sensing circuit 500′ of FIG. 9 is substantially identical to the touch sensing circuit 500 as shown in FIG. 7, except for the latch 534 and the output buffer 535 provided in a calibration unit 540. Thus, the same reference numerals will be assigned to the same elements and detailed description thereof will be omitted in order to avoid redundancy.

The memory 532 may use an additional shift register clock “Shift” to allow 6-bit information stored therein to be sequentially transferred to the latch 534 before the SNI signal becomes a high level in the normal mode. To this end, timing of the SNI signal and timing of the shift register clock “Shift” are controlled such that the shift register clock “Shift” becomes a high level before the SNI signal becomes the high level. The timing of the SNI signal and the timing of the shift register clock “Shift” can be controlled by the control logic such as the timing control unit.

The memory 532 sequentially provides the 6-bit information regarding the sensing voltage Vₛₑₙₛₑ to the latch 534 by one bit in response to the shift register clock “Shift” at the high level. Then, the latch 534 latches the 6-bit information sequentially provided from the memory 532. If the SNI signal is activated to a high level, the latch 534 provides the DAC 533 with the 6-bit sensing voltage Vₛₑₙₛₑ latched therein.

The DAC 533 generates the calibration voltage V_{CALI} by calibrating the input sensing voltage Vₛₑₙₛₑ such that the input sensing voltage Vₛₑₙₛₑ has a level lower or higher by the predetermined voltage difference ΔV (e.g. about 0.1 V to about 0.3V) (see FIG. 5 and FIG. 6). The level of the calibration voltage V_{CALI} is calibrated by changing the distribution rate of the resistor array provided in the DAC 533, or the level of the supply voltage of the DAC 533. The calibration voltage V_{CALI} generated from the DAC 533 is provided to the output buffer 535. Then, the calibration voltage V_{CALI} is provided to the comparison unit 550 through the third switch S13 in the normal mode operation. The switching operation of the third switch S13 is controlled by the SNI signal.

The calibration operation of the present invention as described above can be independently performed relative to all sensors 102 provided in the liquid crystal panel 110. Thus, even if the operation characteristics of the sensors 102 are changed because at least one of the threshold voltage Vₜₕ, mobility, and capacitance C_{SiNx} of the thin film transistor in the sensor 102 is non-uniform, or the gate-source voltage V_{GS} or detection time of the thin film transistor is changed, the calibration voltage V_{CALI} reflecting the changed operation characteristics of the sensors 102 can be generated. As a result, the sensor 102 can be prevented from malfunctioning and the sensing characteristics of the sensor 102 can be improved.

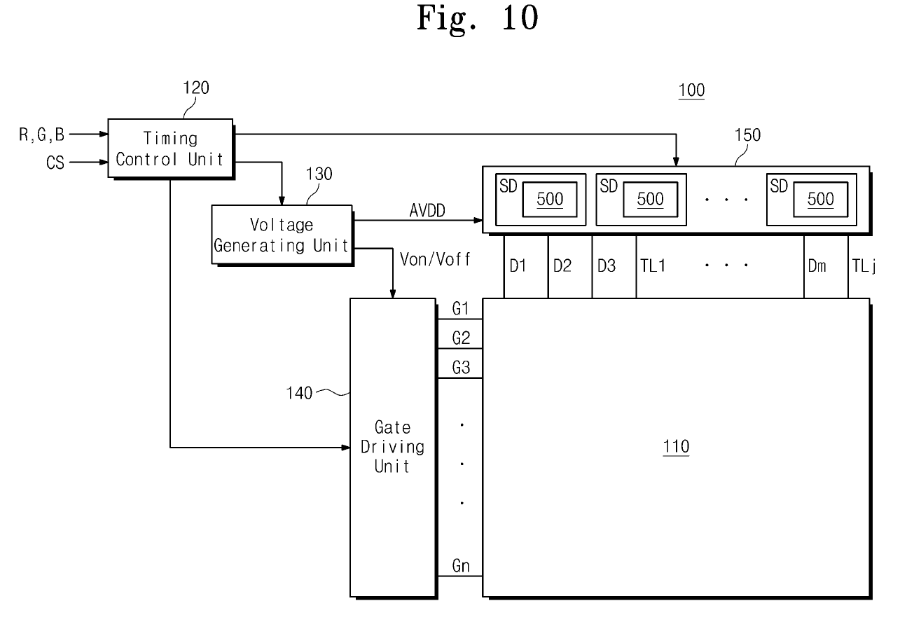

FIG. 10 is a block diagram showing a liquid crystal display including the touch sensing circuit according to the present invention.

Referring to FIG. 10, the liquid crystal display 100 includes the liquid crystal panel 110, a timing control unit 120, a voltage generating unit 130, a gate driving unit 140, and a source driving unit 150.

The liquid crystal panel 110 includes a plurality of pixels 101 (refer to FIG. 1) and a plurality of sensors 102 (refer to FIG. 1). The liquid crystal panel 110 as shown in FIG. 10 includes a liquid crystal panel integrally formed with a touch screen panel, or the liquid crystal panel has a touch screen function. Since the structure of the liquid crystal panel 110 is substantially identical to that of the liquid crystal panel 110 as shown in FIG. 1 and FIG. 2, a detailed description thereof will be omitted in order to avoid redundancy.

The timing control unit 120, the voltage generating unit 130, the gate driving unit 140, and the source driving unit 150 serve as a control apparatus that drives the liquid crystal panel 110. The control apparatus such as the timing control unit 120, the gate driving unit 140, and the source driving unit 150 can be prepared in the form of a control module. Elements constituting the control module can be manufactured in the form of an IC chip so that the elements can be electrically connected with the liquid crystal panel 110. Further, in order to increase the integration degree and simplify the manufacturing procedure, the liquid crystal panel 110 and the gate driving unit 140 can be formed on the same substrate. In such a case, the control module may include the timing control unit 120, the voltage generating unit 130, and the source driving unit 150.

The timing control unit 120 receives RGB image signals and an image control signal CS, which controls display of the RGB image signals, from an external graphic controller (not shown). The RGB image signals include source pixel data (i.e. red, green, and blue data). The image control signal CS includes a vertical sync signal V_{sync}, a horizontal sync signal H_{sync}, a main clock CLK, and a data enable signal DE. The timing control unit 120 processes the RGB image signals according to operation conditions of the liquid crystal panel 110. Further, the timing control unit 120 generates a plurality of control signals including gate and data control signals, a control signal used to detect a sensor, and a control signal used to calibrate voltage detected by the sensor 102 upon the non-touch event.

The voltage generating unit 130 generates various driving voltages for the liquid crystal panel 110 by using an external supply voltage (not shown). The voltage generating unit 130 generates a reference voltage AVDD, a gate turn-on voltage Vₒₙ, a gate turn-off voltage V_{off}, and a common voltage (not shown). The voltage generating unit 130 applies the gate turn-on voltage Vₒₙ and the gate turn-off voltage V_{off} to the gate driving unit 140, and applies the reference voltage AVDD to the source driving unit 150. Meanwhile, the calibration operation performed in the present invention can be achieved by calibrating a resistance value of the resistor array of the DAC 533 provided in the calibration unit 530 or the level of the supply voltage. Thus, the voltage generating unit 130 generates and calibrates the supply voltage required when the calibration operation is performed.

The gate driving unit 140 applies the gate turn-on voltage Vₒₙ and the gate turn-off voltage V_{off} to the gate lines G₁ to Gₙ according to a vertical sync start signal STVP (not shown). The gate turn-on voltage Vₒₙ is sequentially provided to all gate lines G₁ to Gₙ for one frame.

The source driving unit 150 generates a gray scale signal using the data control signal and pixel data signal of the timing control unit 120 and the reference voltage AVDD of the voltage generating unit 130 to apply the gray scale signal to the data lines D₁ to Dₘ. The source driving unit 150 operates in response to the data control signal to convert the digital pixel data signal into the analog gray scale signal by using the reference voltage AVDD. Then, the source driving unit 150 supplies the analog gray scale signal to the data lines D₁ to Dₘ.

The source driving unit 150 includes a plurality of source drive ICs “SD”. Each source drive IC “SD” may include the touch sensing circuit 500 of the present invention. Since the detailed configuration and operation of the touch sensing circuit 500 as shown in FIG. 10 are substantially identical to the touch sensing circuit 500 as shown in FIG. 7, a detailed description thereof will be omitted in order to avoid redundancy.

The touch sensing circuit 500 generates the calibration voltage V_{CALI} using the sensing voltage detected by the sensor 102 in the calibration interval having a non-touch event to the sensors 102. The calibration voltage V_{CALI} is calibrated such that the predetermined voltage difference ΔV (e.g. about 0.1 V to about 0.3V) is formed between the calibration voltage V_{CALI} and the sensing voltage corresponding to the non-touch event (see FIG. 5 and FIG. 6). The calibration voltage V_{CALI} is compared with the sensing voltage detected by the sensor 102 in a normal operation, and is used to detect a touch event to the sensor 102.

FIG. 10 shows a case in which the touch sensing circuit 500 is provided in the source drive IC “SD” of the source driving unit 150. However, the scope of the present invention is not limited thereto. The touch sensing circuit 500 of the present invention can be provided in the source driving unit 150 out of the source drive IC “SD”. Further, the touch sensing circuit 500 can also be provided in the control module or the timing control unit 120 other than the source driving unit 150. In addition, the touch sensing circuit 500 can be provided in various positions of the liquid crystal display 100.

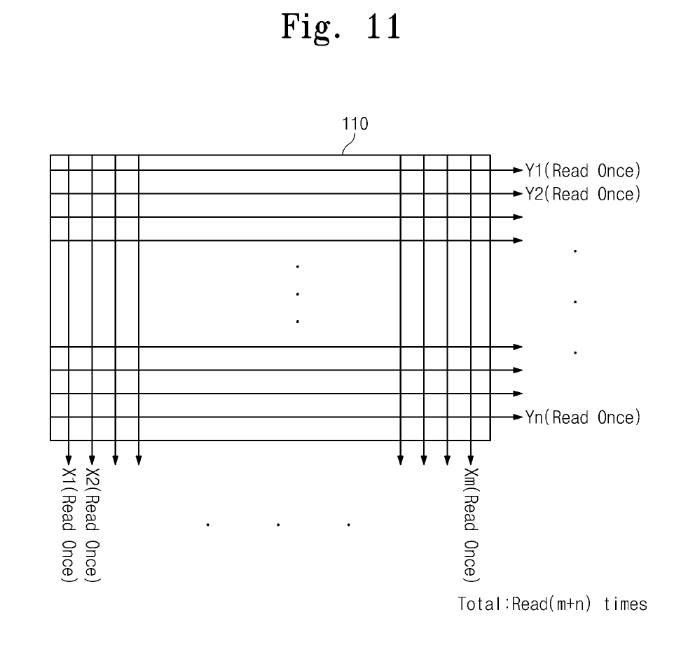

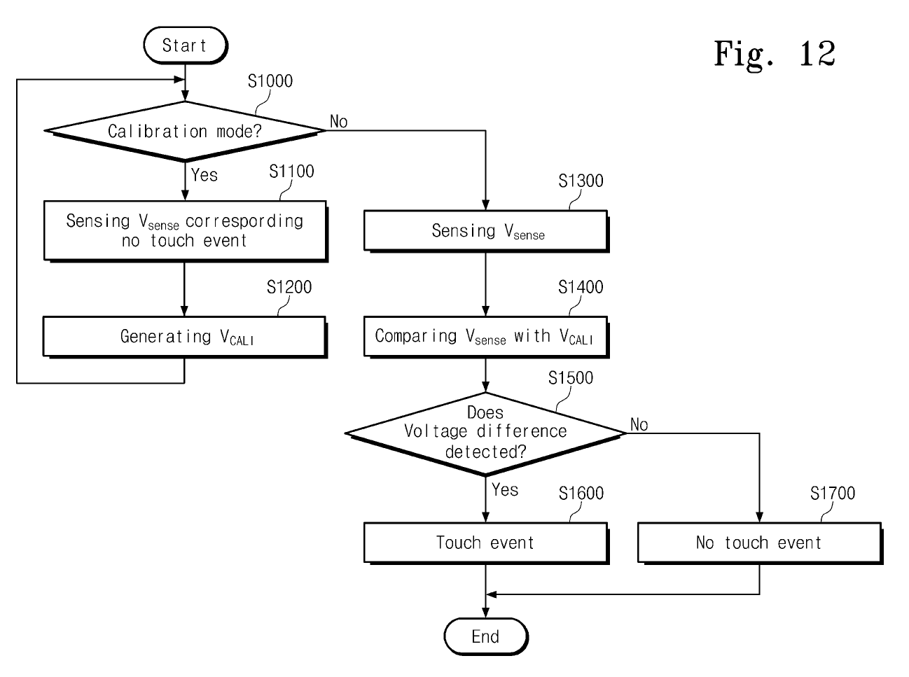

FIG. 11 is a view showing a scanning scheme for sensors provided in the liquid crystal panel.

Referring to FIG. 11, when one sensor line is selected, “m” corresponding sensors perform a sensing operation once. In such a case, data is read from all sensors connected with one sensor line at one time.

In a case in which (m*n) sensors are disposed in the liquid crystal panel 110, the total (m*n) reading operations are required to read sensing voltage from all sensors. When the data read from each sensor includes 6-bit information, the total required storage capacity is (m*n)*6 bits. For example, when a sensor has resolution of (960*540) on the basis of an FHD, a total 3.12 Mbits of storage capacity is required to store the sensing voltage of all sensors through calibration. When the touch sensing circuit 500 of the present invention is provided in each source drive IC “SD” as shown in FIG. 10, the storage capacity required to store the sensing voltage of all sensors is distributed to each source drive IC “SD”. At the present time, eight source drive ICs “SD” are required to drive the FHD on the basis of 720 channels. Thus, when eight source drive ICs “SD” are provided in the source driving unit 150, each source drive IC “SD” may have a required storage capacity of 38.8 Kbits (3.12M/8). Consequently, even if the touch sensing circuit 500 has the calibration function according to the present invention, the substantially required storage capacity may be very small.

Meanwhile, in a case in which all sensors do not store information and information of each sensor line is stored as shown in FIG. 11, a required storage capacity is described below.

Referring to FIG. 11, whenever one sensor line is selected, the “m” corresponding sensor performs a sensing operation once. When “n” gate lines and “m” sensor lines are provided, the total (m+n) reading operations can be performed to read a sensing voltage from all sensor lines. In such a case, when the data read from each sensor line includes 6-bit information, the total required storage capacity is (m+n)*6 bits. For example, when a sensor has a resolution of (960*540) on the basis of the FHD, a total of 9 Kbits of storage capacity is required to perform the calibration. Thus, the required storage capacity may be reduced by about 30 times as compared with the sensor scanning scheme in which the (m*n) sensors perform the (m*n) reading operations. Consequently, additional required storage capacity and the number of parts may be reduced, and the calibration function of the present invention may be performed at a low cost.

FIG. 12 is a flowchart showing a touch sensing operation of the liquid crystal display according to the present invention.

Referring to FIG. 12, the liquid crystal display 100 determines whether an operation mode is a calibration mode or not (S1000). The liquid crystal display 100 may have two operation modes, i.e. the normal and calibration modes. In the calibration mode, a level of voltage is self-calibrated, which is to be used to detect a touch event to the sensor 102 by reflecting operation characteristics of the sensor 102 provided in the liquid crystal panel 110. In the normal mode, user input is normally generated. In the calibration mode, the non-touch event basically occurs in the liquid crystal panel 110. For example, the calibration mode can be variously defined as an interval in which the normal operation is performed and then “n” frames pass (n denotes an integral number of 1 or more) after the liquid crystal panel 110 is turned on.

As a result of the determination in step S1000, when the operation mode is the calibration mode, the touch sensing circuits 500 and 500′ of the liquid crystal display 100 detect the sensing voltage Vₛₑₙₛₑ from the sensor (S1100). The sensing voltage Vₛₑₙₛₑ in step S1100 corresponds to voltage detected when a touch has not occurred in the sensor. The sensing voltage Vₛₑₙₛₑ is converted into a digital signal and stored in a memory. The memory can be prepared in the form of a frame memory provided in the liquid crystal display 100 as well as a memory provided in the source drive IC “SD”. When the memory is provided in the source drive IC “SD”, required storage capacity can be distributed to each source drive IC “SD”. In such a case, a scanning scheme for the sensor is changed or the sensors are connected in parallel with each other, so that capacity of the memory provided in each source drive IC “SD” can be reduced.

Then, the touch sensing circuits 500 and 500′ generate the calibration voltage V_{CALI} from the sensing voltage Vₛₑₙₛₑ in a non-touch state (S1200). The calibration voltage V_{CALI} generated in step S1200 is obtained by decreasing or increasing the level of the sensing voltage Vₛₑₙₛₑ corresponding to the predetermined voltage difference ΔV (e.g. about 0.1 V to about 0.3V) (see FIG. 5 and FIG. 6). According to another exemplary embodiment of the present invention, the calibration voltage may use the sensing voltage Vₛₑₙₛₑ detected when a non-touch event occurs in each sensor. The calibration voltage V_{CALI} is generated for each sensor included in the liquid crystal panel 110.

As a result of the determination in step S1000, when the operation mode is not the calibration mode, the liquid crystal display 100 establishes the normal mode. In the normal mode, the touch sensing circuits 500 and 500′ of the liquid crystal display 100 detect the sensing voltage Vₛₑₙₛₑ from the sensors (S1300). Then, the touch sensing circuits 500 and 500′ compare the sensing voltage Vₛₑₙₛₑ with the calibration voltage V_{CALI} (S1400), and determine whether a difference occurs between the sensing voltage Vₛₑₙₛₑ and the calibration voltage V_{CALI} based on the comparison result or not (S1500).

As a result of the determination in step S1500, when the difference occurs between the sensing voltage Vₛₑₙₛₑ and the calibration voltage V_{CALI}, the touch sensing circuits 500 and 500′ determine that a touch event has occurred in the sensor (S1600). However, when the difference does not occur between the sensing voltage Vₛₑₙₛₑ and the calibration voltage V_{CALI}, the touch sensing circuits 500 and 500′ determine that a non-touch event has occurred in the sensor (S1700).

As described above, the self-calibration operation of the touch sensing circuits 500 and 500′ is performed in an interval having a non-touch event to the liquid crystal panel 110, e.g. when the normal operation is performed and then “n” frames pass (n denotes an integral number of 1 or more) after the liquid crystal panel 110 is turned on, or in a user selection mode. Such a calibration operation is performed relative to all sensors provided in the liquid crystal panel 110. Thus, even if characteristics of the sensors provided in the liquid crystal panel 110 are changed due to process variation, the changed characteristics of the sensors can be reflected through the calibration operation. Consequently, whether the sensor is touched can be exactly determined, and a touch event of the liquid crystal panel 110 having a touch screen function can be detected without an error. The touch sensing method of the present invention as described above can be applied to all liquid crystal panels having a touch screen therein and using variation in current applied to sensor lines generated therein.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A liquid crystal display comprising:
a liquid crystal panel that has a plurality of pixels and a plurality of sensors; and
a touch sensing circuit that compares a sensing voltage detected by at least one sensor with a reference voltage that corresponds to the at least one sensor to determine whether the at least one sensor is touched or not,
wherein a level of the reference voltage is calibrated by taking operation characteristics of the sensors into consideration.

2. The liquid crystal display of claim 1, wherein the touch sensing circuit performs a calibration operation of calibrating the level of the reference voltage at least once before a normal operation in which a user input occurs.

3. The liquid crystal display of claim 2, wherein the calibration operation is performed using a voltage detected when a non-touch event occurs in the sensors.

4. The liquid crystal display of claim 3, wherein the touch sensing circuit generates the voltage detected upon the non-touch event as the reference voltage.

5. The liquid crystal display of claim 3, wherein the touch sensing circuit increases or decreases a level of the voltage detected upon the non-touch event during the calibration operation, and generates the increased or decreased voltage as the reference voltage.

6. The liquid crystal display of claim 5, wherein the level of the voltage detected upon the non-touch event is increased or decreased by changing a distribution rate of a resistor array and a level of a supply voltage of the touch sensing circuit.

7. A liquid crystal display comprising:
a liquid crystal panel that has a plurality of pixels and a plurality of sensors;
a driving unit that generates a data voltage that corresponds to an image signal to be displayed on the pixels;
a touch sensing circuit that compares a sensing voltage detected by at least one sensor with a reference voltage that corresponds to the at least one sensor to determine whether the at least one sensor is touched; and
a timing control unit that controls operations of the driving unit and operations of the touch sensing circuit,
wherein a level of the reference voltage is calibrated by taking operation characteristics of the sensors into consideration.

8. The liquid crystal display of claim 7, wherein the touch sensing circuit is provided in the driving unit or the timing control unit.

9. The liquid crystal display of claim 7, wherein the touch sensing circuit comprises:
an integration unit that generates the sensing voltage from a sensing current generated from each sensor;
a calibration unit that generates a calibration voltage that corresponds to each sensor from the sensing voltage generated from the integration unit during a calibration operation, and provides the calibration voltage as the reference voltage during a normal operation; and
a comparison unit that compares the sensing voltage generated from the integration unit during the normal operation with the reference voltage to determine whether the touch occurs to the sensor or not.

10. The liquid crystal display of claim 9, wherein the calibration unit comprises:
an analog-to-digital converter that converts the sensing voltage generated from the integration unit during the normal operation into a digital voltage;
a memory storing the digital that senses voltage; and
a digital-to-analog converter that converts the sensing voltage stored in the memory into an analog signal to generate the calibration voltage,
wherein a level of the calibration voltage is calibrated using at least one of a distribution ratio and a supply voltage of resistors provided in the analog-to-digital converter.

11. The liquid crystal display of claim 10, wherein the calibration unit comprises:
a latch that sequentially latches bits of the sensing voltage stored in the memory and that simultaneously provides the latched bits to the digital-to-analog converter; and
an output buffer that provides an output of the digital-to-analog converter to the comparison unit.

12. The liquid crystal display of claim 10, further comprising a voltage generating unit that generates and calibrates the supply voltage.

13. The liquid crystal display of claim 9, wherein the calibration operation is performed at least one time before the normal operation is performed.

14. The liquid crystal display of claim 9, wherein the calibration voltage comprises a voltage detected from each sensor upon a non-touch event.

15. The liquid crystal display of claim 14, wherein the calibration voltage is obtained by increasing or decreasing a level of the voltage detected from each sensor upon the non-touch event.

16. The liquid crystal display of claim 15, wherein the level of the voltage detected upon the non-touch event is increased or decreased by changing a distribution rate of an internal resistor array and a level of a supply voltage.

17. A touch sensing method of a liquid crystal panel having a plurality of pixels and a plurality of sensors, the touch sensing method comprising:
generating a calibration voltage that corresponds to each sensor in consideration of voltage characteristics of each sensor that corresponds to a non-touch event during a calibration operation;
receiving a sensing voltage from at least one sensor during a normal operation;
comparing the sensing voltage with the calibration voltage corresponding to the at least one sensor; and
determining whether the at least one sensor is touched based on a result obtained by comparing the sensing voltage with the calibration voltage.

18. The touch sensing method of claim 17, wherein the calibration voltage is generated for each sensor provided in the liquid crystal panel.

19. The touch sensing method of claim 17, wherein the calibration operation is performed at least one time before the normal operation is performed.

20. The touch sensing method of claim 17, wherein the generating of calibration voltage comprises:
converting the sensing voltage detected from each sensor into a digital sensing voltage;
storing the digital sensing voltage in a memory; and
converting the sensing voltage stored in the memory into an analog voltage to generate the calibration voltage,
wherein a level of the calibration voltage is calibrated such that a predetermined difference occurs between the calibration voltage and the sensing voltage detected from each sensor.
